(19) United States
(12) Patent Application Publication
(10) Pub. No.: US 2022/0383290 A1
(43) Pub. Date: Dec. 1, 2022

(54) INTERACTIVE METHOD FOR RURAL BARTER

(71) Applicant: André Augusto CEBALLOS MELO, São Paulo (BR)

(72) Inventor: André Augusto CEBALLOS MELO, São Paulo (BR)

(21) Appl. No.: 17/736,327

(22) Filed: May 4, 2022

(30) Foreign Application Priority Data
May 27, 2021 (BR) 10 2021 010251 9

(51) Int. Cl. G06Q 20/22; G06Q 20/06; G06Q 20/38; G06Q 30/06

(52) U.S. Cl. CPC G06Q 20/223; G06Q 20/065; G06Q 20/389; G06Q 30/0619; G06Q 2220/00

(57) ABSTRACT

A new interactive method for Barter destined specifically for the rural area, which refers to a new embodiment of token unbacked by computer processing. Where the Barter becomes an operation with tokenized asset associated to marketplaces/hub, social networks, and hubs, in a platform which mixes social network elements with e-commerce, with the purpose of approximating buyers and sellers who use Barter operations and further providing a space for exchange of information, with the creation and facilitating of smart contracts. Where the tokens are used for interactions with producers and suppliers in a marketplace mixed with social media, taking into account the trustfulness generated by the feedback with the social networks.

### FIELD

The present invention refers to a new interactive method for Barter destined specifically for the rural area, which refers to a new embodiment of token unbacked by computer processing. Where the Barter becomes an operation with tokenized asset associated to marketplaces/hub, social networks, and hubs, in a platform which mixes elements of social network with e-commerce, with the purpose of approximating buyers and sellers who use Barter operations, and further providing a space for exchange of information, with the creation and facilitation of smart contracts. Where the tokens are used for interactions with producers and suppliers in a Marketplace mixed with social network, considering the trustfulness generated by feedback with the social networks.

### BACKGROUND

There exist some patent documents which describe method and platforms based on Barter, however, none of these documents anticipates the configuration, working, and application in the rural area, as described in this invention. Among these documents, the following can be highlighted:

Patent document WO2020228605A1, BARTER SOFTWARE PLATFORM AND METHOD, which discloses a barter software platform and method. The platform comprises a display and selection module, which is for a user to select an article to form a closed exchange circle to perform relay exchange; and further comprises a registration and login module, an addition and deletion (withdrawal) module, a confirmation and transport module, a scoring and recording module and a central processing module, which are integrated with the display and selection module, and are used to carry out a registration verification or login operation of a user, add or delete (withdraw) relevant article information, confirm, implement and process exchange, score a user behavior and record the score, etc. The software platform is simple in structure and easy to operate, and can dearly present the information on the exchanged articles for the user to perform browsing and selection in a convenient and quick manner, such that direct barter of articles in large areas is achieved, and the user can obtain a favorite article by means of exchange at relatively low expense, such that some idle articles and resources are returned to society and continue to exert greater material benefits, thus not only is the aim of saving of the user realized, but also resources are saved for the country and society;
Patent document KR20190141876A, BARTER MEDIATION METHOD, wherein there is disclosed is a barter brokerage method for brokering barter between a plurality of users. According to an embodiment of the present inven tion, a barter brokerage method in a barter brokerage system connected to client terminals on a network comprises the steps of: receiving barter goods information about goods to be bartered and barter method information about a barter method from the client terminals; storing the barter goods information and the barter method information in a storage unit storing user identification information for identifying a user of each of the client terminals; generating barter matching information based on the barter goods information and the barter method information; and transmitting the barter matching information to die nt terminals based on the user identification information. The present invention can correctly match users corresponding to conditions of goods for barter;
Patent document CN110378792A, INTERNET-BASED BARTER METHOD, wherein the invention relates to an Internet-based barter method. The method comprises the steps: obtaining barter information input by a first barter user, and the barter information comprises first user information, to-be-exchanged cargo information and target cargo information; determining the number of right coins allocated to the first barter according to the related information, and sending the corresponding number of right coins to the first barter by the barter server; sending barter information to a server; sending a goods viewing request to a barter server, the goods viewing request including the first user information, and determining target goods from the alternative goods data according to the first barter user; initiating a barter request to a barter server, the barter request including target cargo information and second barter terminal information, the target cargo being provided by a second barter terminal; and sending the first guarantee fund payment request to a server. The credit guarantee system is established, the unified transaction rule is established, and the whole transaction process is supervised by using the barter terminal and the barter server so that barter information communication is enabled to be smooth and barter transaction can be smoothly completed;
Patent document KR20190111235A, BARTER EXCHANGE TRADING BALANCE MANAGEMENT AND CREDIT DEBT MANAGEMENT SYSTEM AND METHOD FOR MULTILATERAL BARTER EXCHANGE TRADING, wherein there is provided an exchange transaction balance management and credit debt management system of multilateral exchange transaction, and a method thereof. A purchase transaction and a sale transaction which were simultaneously performed by one party of an exchange transaction in a multilateral exchange transaction through electronic money are separated, a transaction imbalance which inevitably occurs, and credit debt problems of a purchase trader may be diagnosed, managed, and solved;

Patent document US2018032688A1, EDGE TESTS IN BARTER EXCHANGES, an embodiment that provides a system including, but not necessarily limited to: a processor; a memory in communication with the processor; and computer readable program executable by the processor and configured to: receive, for one or more edges, testing data; store, for the one or more edges, testing data. Other aspects are described and claimed; and

Patent document CN108921685A, CREDIT ASSESSMENT METHOD FOR REALIZING CREDIT BARTER, AND CREDIT BARTER PLATFORM, wherein the embodiment of the invention discloses a credit assessment method for realizing credit barter, and a credit barter platform. The credit assessment method comprises the steps that after related information, generated by the registered users in the credit barter platform, at least comprising registered user basic information, product information and transaction behavior information of registered users in the credit barter platform is obtained, the credit line values assigned to the registered users are determined according to the related information, and the total credit line value of registered user credit accounts is updated according to the credit line values. By implementing the credit assessment method, the good barter experience can be provided for the registered users based on reliable platform transactions and the self-conscious registered users.

### SUMMARY

The interactive method for rural Barter, object of the present invention, is destined more specifically to the rural area, where the great importance of Barter is to guarantee to the farmer the purchase of inputs or machinery for his harvest without the need for him to take money from his pocket and to promote the intersection between small businesses and farmers.

The interactive method for rural Barter, object of the present invention, has as main purpose to provide to the farmer an embodiment of token unbacked by computer processing, which provides the intersection between small businesses and farmers, and guarantees to the farmer the purchase of inputs or machinery for his harvest without the need to take money from his pocket, carried out by means of the integration with communication applications (WhatsApp) and a chat tool for sellers to interact with their clients, and further, comprising a crop financing mechanism by means of the exchange of inputs, such as fertilizers, seeds and pesticides by farmers, without monetary intermediation.

There is a need for financing and rural credit, and the use of technology and information is critical for this purpose. On the other hand, the intersection between small companies and farmers is more important than ever. Thus, a new embodiment of token unbacked by computer processing, is beneficial and advantageous, offering agility and efficiency in agribusiness transactions and avoiding the causes for greenhouse gas emissions due to the consumption of energy.

It is known that Barter already represents 40% of the purchases of inputs in Brazil in the 2019/2020 harvest. Being a crop financing mechanism, by means of the exchange of inputs, such as fertilizers, seeds, and pesticides by farmers, without monetary intermediation.

As a guarantee of receipt from the farmers, the suppliers sign agreements and, in most of the cases, receive from the farmers the Rural Product Note (CPR), which backs the operation, transferring the agreed amount of the harvest. Thus, the major importance of Barter is to guarantee to the farmer the purchase of inputs or machinery for his harvest without the need to take money out of his pocket.

Therefore, the method proposed herein aggregates ease for these operations and guarantees the safety, ease of use and functionality thereof.

### DETAILED DESCRIPTION OF THE EMBODIMENTS

The interactive method for rural Barter, object of the present invention refers to a software-controlled method which turns Barter into an operation with tokenized asset associated to marketplaces/hub, social networks, and hubs, in a platform which mixes elements of social network withe-commerce, with the purpose of approximating buyers and sellers who use Barter operations, and further providing a space for exchange of information, with the creation and facilitation of smart contracts.

The tokens are used for interactions with farmers and suppliers in a Marketplace mixed with social network, taking into account the trustfulness generated by feedback with the social network. In this manner, providing the interaction thereof with communication applications (WhatsApp) and a chat tool for sellers to interact with their clients.

The token is used to carry out transactions in these identity related services. The records of the transactions are stored in the blockchain/database. This creates an economy wherein all are rewarded for participating. In this configuration, all the participants can reach their goals.

In this embodiment, the farmer makes an anticipated purchase without paying anything in the act. Thus, to achieve the inputs that he needs, the farmer must sign a contract wherein he undertakes to deliver part of his next crop. This is done by means of a document called Rural Product Note or CPR, which is the key piece for this type of transaction. With the CPR it is possible to generate tokens.

This is how it works: the farmer fixes the price for part of his future crop, using a value corresponding to his costs. With the fixed production cost, this farmer is protected from variations in the interest rate and in the price of commodities. Thus, he will guarantee the best condition to manage his profitability.

According to article 1 of Law 8.929, the CPR is a clear and indisputable title, which represents “the promise of delivery of rural products”. Therefore, it does not establish a price, only details the quality and quantity of the product which must be delivered. [021] Traceability of critical operations.

Drafting the best strategies to reduce or transfer their risks, such as, for example, the Parametric Insurance which helps to protect the crop against the impacts of weather conditions.

Reputation system which evaluates the suppliers of the platform based on quality, sales, and client perception criteria.

To share their feedback and help other people in the Marketplace, it is possible to classify the buyers and sellers with whom he interacted.

A score that entitles to a seal of quality.

Identify the performance of shopkeepers and farmers, guaranteeing credibility to rural partner producers and the e-commerce. Additionally, advertisements with good quality can appear highlighted in the e-commerce channel, favoring the exchange of tokens for products.

Thus, the closer the members of this chain work, the greater will be the overall benefit.

Additionally, the token can be generated from paid environment conservation and recuperation initiatives, environmental voluntary market for the projects to receive anticipated income and liquidity to guarantee the full development thereof. It enables structuring and scaling the environmental services market by generating tokens to provide credibility and financial security to projects as a reward for those who protect natural resources.

Several services are offered by the marketplace/hub. The marketplace/hub offers a comprehensive range of innovative and high-quality services. Even financial support and insurance by means of partnerships with fintechs. Which might be:

### Labor Service:

Solution for labor challenges with offers of qualified workers from selected sources. Find the perfect fit in terms of qualified and experienced labor, including: harvest, tractor drivers, construction, electrics, welding and much more. With token validated exchanges.

The marketplace/hub unites screened buyers and sellers in a safe platform that is easy to use where exchanges are made verified by a token system.

The sellers can directly add unique items or upload all their inventory of equipment and parts using our convenient tool.

Potential buyers can review lists, ask questions, make offers, or create wish lists.

All this is provided in a convenient place, to simplify the supply of parts, equipment, and agricultural services.

Where the marketplace/hub offers a broad list of services which can be: Labor Service, Creating Offers service; Service for construction of a network; Notification service; Certified services; Benefits services; Security services; Trustworthy Partnership Services; and Quality Services, among others: [037] Creating offers service:

The marketplace/hub allows buyers to search the parts and equipment that they need, analyze detailed information, and negotiate a price by making an offer. The sellers can approve offers or make counteroffers. [039] Service for construction of a network:

The marketplace/hub allows buyers and sellers to communicate and define their own sales terms. The buyers can even mark the lists with Favorites and subsequently review them.

### Notification Service:

The marketplace/hub allows buyers and sellers to receive notifications directly on the site and reply to them. The notifications are clearly shown and easy to access.

### Certified Services:

The token allows the exchange of a broad variety of innovative services of generating credit, validated by a token system. Combining services, inputs, parts, and equipment, all your supply needs can be met in only one convenient place.

### Benefits Services:

The marketplace/hub places the user in control: buy, sell, or do both things. Creates partnership opportunities, offering benefits to the members.

### Security Services:

The marketplace/hub is a safe platform with verified buyers and sellers.

### Trustworthy Partnership Services:

The partner companies will be carefully selected for service and quality to the client.

### Quality Services:

The offers of services of the Marketplace/hub are innovative and pioneers in the sector.

Advantages

In this manner, the interactive method for rural Barter, object of the present invention, as described above, with a filtering element submitted to a thermo-chemical treatment which aims at increasing the resistance thereof to abrasion by means of surface hardening. It presents a new and unique configuration which grants several great advantages. Among these advantages the following can be cited: generating tokens automatically, from the barter operations; the integration with communication apps; the facility in preparing digital contracts (safety of the contracts, Rural Product Note (CPR)); the traceability of the critical operations; the fact of being able to outline the best strategies to reduce or transfer their risks, such as, for example, the Parametric Insurance which helps to protect the crop against the impacts of weather conditions; the fact of presenting a reputation system which evaluates the platform suppliers based on quality, sales and client perception criteria; and the fact of being able to share their feedback and help other people in the Marketplace, it being possible to classify the buyers and sellers with whom you interacted.

Additionally, it provides more agility and efficiency to the Barter. In short, the organization of the chain occurs in the following manner: farmer: has the product to deliver in exchange for inputs or machinery; inputs or machinery supplier: wishes to sell pesticides, fertilizers, seeds, combine harvesters, tractors etc., and the trading or grain consumer: is interested in the grain for sale or consumption. The more the application is used, the greater the trust by third parties in the digital identity stored in the platform.

Thus, by the configuration and working characteristics described above, it can be clearly observed that the INTERACTIVE METHOD FOR RURAL BARTER refers to a new method for the State of the Art which comprise the unpublished novelty, inventive activity and industrial application which makes them deserve the Patent of Invention Privilege.

1. A method for interactive barter that method makes barter an operation with a tokenized asset associated to marketplaces/hub, social networks and hubs, in a platform which mixes social network elements withe-commerce, comprising using tokens for interactions with farmers and suppliers in a markeplace mixed with social network, and carrying out transactions in these services related to identity; wherein the records of the transactions are stored in the blockchain/database; wherein the marketplace/hub offers a list of services comprising: labor service, creating offers service; service for construction of a network; notification service; certified services; benefits services; security services; trustworthy partnership services; and quality services.

2. The method according to claim 1, further comprising signing a contract with the commitment to deliver part of the next crop, by a document called Rural Product Note or CPR, and generating the tokens.

3. The method according to claim 1, wherein the token is generated from paid environment conservation and recuperation initiatives, environmental voluntary market for the projects to receive anticipated income and liquidity to guarantee the full development thereof, enabling structuring and scaling the environmental services market by generating tokens to provide credibility and financial security to projects as a reward for those who protect natural resources.
